(19) United States
(12) Patent Application Publication
(10) Pub. No.: US 2012/0243940 A1
(43) Pub. Date: Sep. 27, 2012

(54) APPARATUS FOR CONTROLLED RELEASE OF WATER FOR PLANTS

(76) Inventor: Jon Thenhaus, Beaverton, OR (US)

(21) Appl. No.: 13/490,678

(22) Filed: Jun. 7, 2012

Related U.S. Application Data
(63) Continuation-in-part of application No. 13/210,869, filed on Aug. 16, 2011.
(60) Provisional application No. 61/393,994, filed on Oct. 18, 2010.

(51) Int. Cl. A01G 25/16; F16K 31/18

(52) U.S. Cl. 405/37; 137/409; 405/36

(57) ABSTRACT

An apparatus for controlled release of water for plants includes a chamber; a damper that allows the water into the chamber; and a float having a drain tube. The float is adapted to rise with the water level in the chamber to a predetermined upper level, sink, and substantially release the water through the drain tube. The chamber is positioned inside or adjacent to a grow bed. Water from a fish tank may be pumped into the grow bed through a conduit in the chamber, and the apparatus periodically drains a measured amount of water back to the fish tank.

### RELATED APPLICATIONS

This application claims the benefit of the filing date of U.S. patent application Ser. No. 13/210,869, filed Aug. 16, 2011, which is incorporated herein by reference in its entirety; and U.S. Patent Application No. 61/393,994, filed Oct. 18, 2010, which is incorporated herein by reference in its entirety.

### BACKGROUND OF THE INVENTION

The present invention generally relates to water management and more specifically to an apparatus for controlled release of water for plants.

Currently, timer systems that are used to control the flow of nutrient water may have periods where effluent hardens and becomes less viscous which may cause failures and anaerobic pockets due to water flow restriction. A mechanical device that provides ebb and flow of nutrient water on a continuous basis without the use of a timer could overcome such problems.

It would be desirable to have a mechanical device that provides ebb and flow of nutrient water on a continuous basis without the use of a timer.

### SUMMARY OF THE INVENTION

In one aspect of the present invention, a device for controlled release of water includes a chamber; a damper that allows the water into the chamber; and a float having a drain tube; wherein the float is adapted to rise with the water level in the chamber to a predetermined upper level, sink, and substantially release the water through the drain tube.

In another aspect of the present invention, a apparatus includes a chamber; a damper for restricting and channeling a flow of water in and out of the chamber; and a dosage float for measuring a volume of the water within the chamber and controlling ebb and flow of the water in and out of the chamber.

In yet another aspect of the present invention, a method for providing ebb and flow of water to a grow bed for plants includes positioning a chamber having a damper and a dosage float inside or adjacent to the grow bed; receiving the water from a water source and providing the water to the grow bed; utilizing the damper to restrict and channel a flow of the water in and out of the chamber; and utilizing the dosage float to periodically release a measured volume of water back to the water source.

### BRIEF DESCRIPTION OF THE DRAWINGS

FIG. 1 is a side view of an embodiment of the present invention;

FIG. 2 is a perspective view of the embodiment of FIG. 1;

FIG. 3 is a view of an embodiment of the present invention including a mechanical filter; and p FIG. 4 is a view of the embodiment of FIG. 1 with the dosage float in the up position.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides an apparatus that controls the flow of nutrient water in a polyculture, aquaponic, and/or hydroponic grow bed. A mechanical device may provide ebb and flow of nutrient water on a continuous basis, and may maintain a constant water exchange.

Embodiments of an apparatus may provide ebb and flow of nutrient water on a continuous basis, and may be referred to as a continuous ebb and flow chamber or CEF chamber. Embodiments of a CEF chamber may be placed within or alongside a grow bed, which may contain different types of medium used to support the roots of the plants. Water may be continuously pumped from a source conduit in the chamber, such as from a fish tank or other nutrient water source, and out an inflow or release conduit to flow onto a grow bed or other water bed. Dampers may include walls with slots to channel and control water from the grow bed into the chamber, yet help prevent the grow bed medium itself from entering the chamber. The slots may have a width that is generally smaller than ¼″. As water floods the chamber, a dosage float at the end of a drain tube rises so that an opening in the float is kept above the water line. When the water level rises to a predetermined upper level, the float cannot rise any further, so water begins to pour into the opening in the float. The float becomes negatively buoyant, so this causes the float to sink to near the bottom of the chamber, where it continues to drain the chamber and grow bed until nearly empty. When the water level has ebbed sufficiently low, the float begins to rise and the cycle repeats. This may provide a controlled release of water for the plants.

Embodiments may include polyculture equipment, which may be constructed of building materials such as wood, metal, glass, acrylic, and/or plastic. The materials may then be coated with a polyurea and/or polyaspartic polyurea material to create a durable water-proof seal on the intended surfaces. Once coated, glass and/or acrylic windows may be affixed using silicone in place. The coating may then applied around the edges to bond the glass and/or acrylic in place. Materials and methods for manufacturing polyculture equipment are described in U.S. patent application Ser. No. 13/210,869.

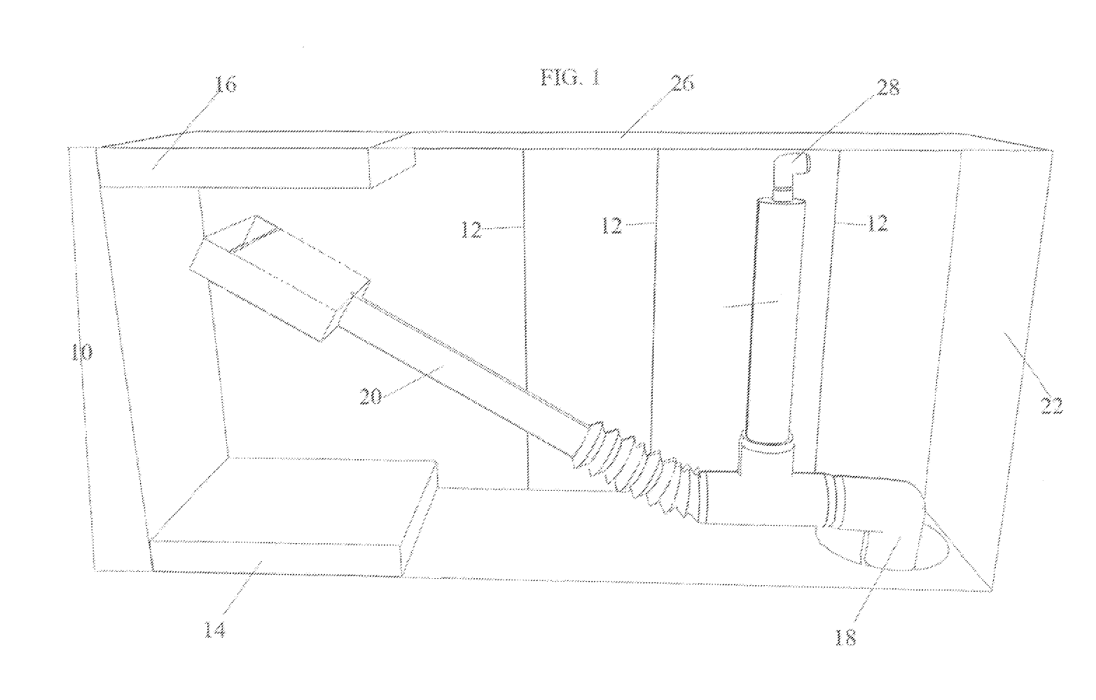

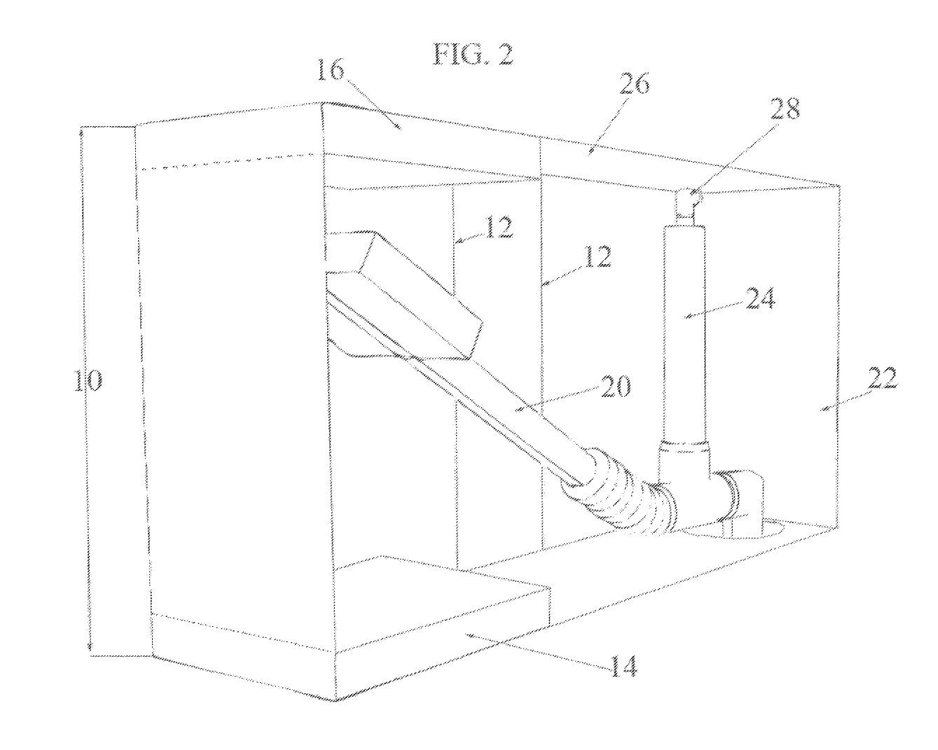

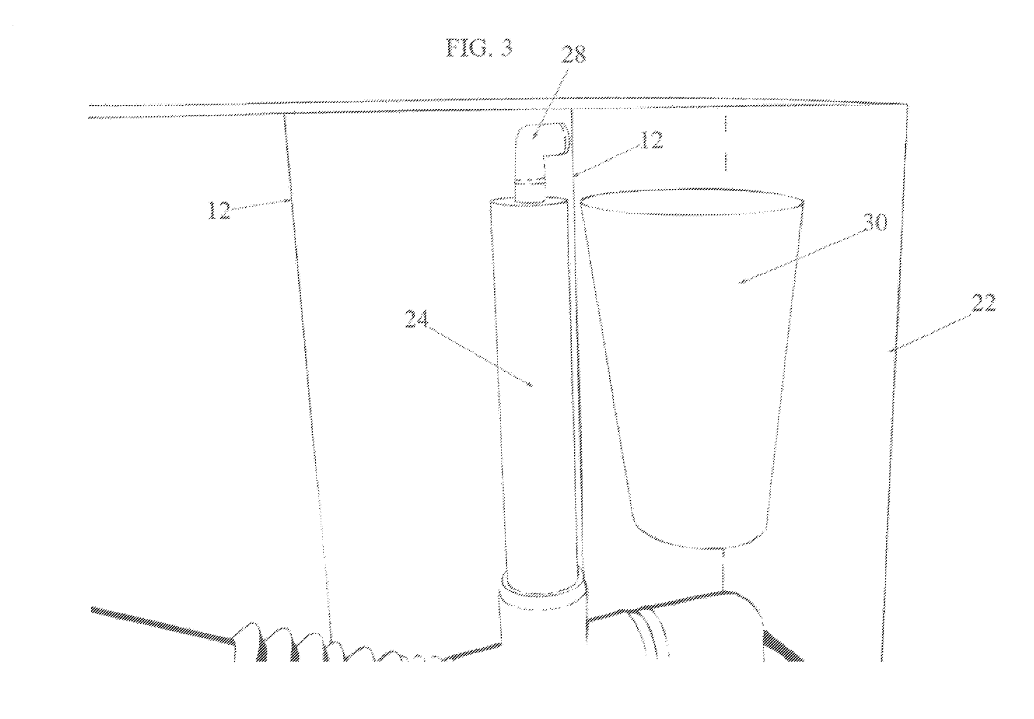

As illustrated in FIG. 1 and FIG. 2, embodiments of an apparatus may include a chamber 10, damper slots 12, mechanical stops 14 and 16, a drain 18, a dosage float 20, supports 22, an overflow 24, a top 26, and an inflow 28. In the figures, the front side of the chamber 10 has been removed. The front wall support is not shown, to see inside the chamber.

Chamber 10 may be constructed of a bottom, four structural wall supports 22 to form walls or sides, and a top 26. The chamber may be placed inside the grow medium, and the structure may help separate the float mechanism from the grow bed medium in order to prevent clogs. The structural supports 22 may also be constructed of a food safe material or other polyculture equipment such as wood, metal, and/or plastic that has enough structural strength to withstand the pressures exerted by the water and grow bed medium.

Damper slots 12 in the structural wall supports 22 may restrict and channel the flow of water in an out of the chamber 10 so the flow rate is within a functional range of the dosage float 20. Slots may include apertures or openings in a wall, or spaces between the walls, and may be small enough that rocks, elements of the grow bed, or other debris will not get in, thereby providing a damper. When water flows into the grow bed and chamber 10, the dosage float 20 may rise with the level of water until it hits the mechanical stop 16. The distance the dosage float 20 rises may also be limited by the length of the pipe. The mechanical stops 14 and 16 may be positioned at predetermined upper and lower levels in order to restrict the distance the dosage float 20 travels so that an accurate measurement of the volume of water within the grow bed can be made.

When the dosage float 20 fills with water, it may sink and hit the mechanical stop 14 which keeps the dosage float 20 elevated enough to drain the chamber and grow bed. The water may be returned, possibly to a fish tank, out a drain 18. In the event of an issue, an overflow 24 may also have a pre-measured overflow height to prevent the water from overflowing in case of malfunction. The overflow tube may trigger the ebb & flow of water or may prevent overflow in case of malfunction. In the event that water stops flowing in the grow bed, the chamber 10 may also have a slow drain located in a return elbow of the drain 18 to keep root rot from occurring. In embodiments, the cycle of water flow may continue indefinitely as long as water is flowing into the apparatus.

In order to use an embodiment in conjunction with a grow bed, a hole may be cut for a bulkhead to be installed in the grow bed. The dosage float and piping may then be connected to the bulkhead, which may form the bottom of the chamber. The rest of the chamber may then be placed inside or adjacent to the grow bed over the dosage float. Water flowing into the grow bed may be through the apparatus, using the inflow, or through another water source or spot in the grow bed. From there, embodiments may measure nutrient rich water coming from a polyculture and/or aquaponic fish tank or nutrients from a hydroponic nutrient tank. This may allow the apparatus to provide a continuous flow of water, constant filtration, and oxygenation via the ebb and flow in order to keep the effluent viscous and prevent anaerobic pockets.

Embodiments of an apparatus may be configured with a dosage float 20 that has long lengths of pipe in order to achieve similar functionality without the mechanical stops 14 and 16.

FIG. 1 and FIG. 2 illustrate an embodiment having a 90 degree downturn at the end of the dosage float 20. Other embodiments may have a straight pipe. Furthermore, the top 26 may be optional for providing cross support and prevent algae growth in the chamber 10. The inflow 28 may also be an optional element where water may be pumped into the grow bed via the chamber 10. Water from a fish tank may come into the chamber and flow out the inflow 28 and into the grow bed. Water may also enter the overflow 24 tube and flow down the drain 18, back into the fish tank.

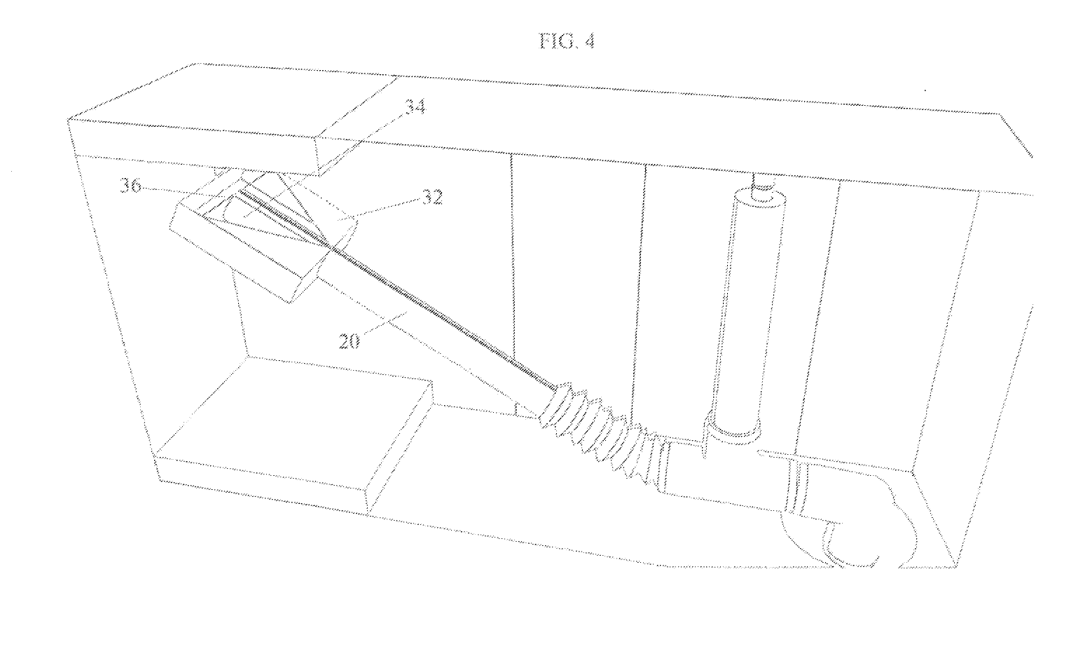

As depicted in FIG. 3, an embodiment of a chamber may also be equipped with a mechanical filter 30. Nutrient-rich water may flow out the inflow 28, through the filter 30, and then trickle down to the grow bed or chamber. The filter may be placed inside the chamber.

As depicted in FIG. 4, an embodiment may include a dosage float 20 having a head 32 at one end. Water may come into the chamber and grow bed. The head has a drain tube 34 and an opening 36. Head 32 is initially buoyant, so that the head 32 rises. When the water level goes up, the dosage float 20 bends so that the head 32 lifts up. When head 32 no longer rises water flows into the opening 36 so that the dosage float 20 is no longer buoyant. The dosage float 20 sinks, the water drains through the drain tube 34 until the head 32 is sufficiently empty, and then the cycle repeats.

Embodiments of an apparatus may include a chamber; at least one damper for restricting and channeling a flow of water in and out of the chamber; a dosage float for measuring a volume of water within the chamber and controlling ebb and flow of water in and out of the chamber; and an overflow to trigger the ebb and flow of water in case of a malfunction in the dosage float.

I claim:

1. A device for controlled release of water, comprising:
a chamber;
a damper that allows the water into the chamber; and
a float having a drain tube;
wherein the float is adapted to rise with the water level in the chamber to a predetermined upper level, sink, and substantially release the water through the drain tube.

2. The device of claim 1, wherein the float enters a buoyant state, the float rises with a water level in the chamber to the predetermined upper level where the float is prevented from further rising, the float receives the water into an opening in the float so that the float transitions to a non-buoyant state, the float sinks to a predetermined lower level, the float substantially releases the water out the drain tube, and the float transitions back to the buoyant state.

3. The device of claim 1, further comprising an upper stop that prevents the float from rising above the predetermined upper level.

4. The device of claim 1, further comprising a lower stop that prevents the float from sinking below the predetermined lower level, so that the drain tube is kept in an orientation that drains the water out of the chamber until the float transitions to the buoyant state.

5. The device of claim 1, wherein a first end of the drain tube extends into the float so that the float becomes non-buoyant when the float starts to receive the water, and a second end of the drain tube is attached to a drain in the chamber so that the water drains out of the chamber.

6. The device of claim 1, further comprising an overflow tube to prevent the water from overflowing if the float malfunctions.

7. The device of claim 1, wherein the damper includes walls with slots that allow water into and out of the chamber, but help prevent debris from getting into the chamber.

8. The device of claim 1, wherein the chamber is adapted to be used with a grow bed supplied by a water source, so that water from the grow bed flows into the chamber and the device periodically drains a measured amount of water outside of the grow bed, thereby controlling the ebb and flow of water across the grow bed.

9. The device of claim 8, further comprising an inflow that provides the water from the water source to the grow bed.

10. The device of claim 8, further comprising a slow drain.

11. The device of claim 8, further comprising a mechanical filter that filters the water supplied to the grow bed.

12. The device of claim 8, wherein the water source is a fish tank and water from the fish tank is pumped into the grow bed through a conduit in the chamber.

13. An apparatus comprising:
a chamber;
a damper for restricting and channeling a flow of water in and out of the chamber; and
a dosage float for measuring a volume of the water within the chamber and controlling ebb and flow of the water in and out of the chamber.

14. The apparatus of claim 13, further comprising an overflow tube to prevent the water from overflowing if the float malfunctions.

15. The device of claim 13, wherein:
the chamber is adapted to be used with a grow bed for plants and a fish tank;
the apparatus includes a conduit that receives the water from the fish tank and provides the water to the grow bed;
the chamber releases the measured volume of the water to the fish tank; and
the damper includes walls with slots that allow the water from the grow bed into and out of the chamber, but help prevent debris from getting into the chamber.

16. The apparatus of claim 13, further comprising:
a drain in the chamber;
an opening in the float; and
a drain tube that connects the float to the drain so that the measured volume of water enters the opening in the float and is drained out of the chamber;
wherein the float becomes buoyant;
the water level rises but the opening in the float stays above a water level in the chamber;
the float rises to a predetermined upper level where the float cannot further rise;
the water level further rises and the float receives the water into the opening until the float becomes non-buoyant;
the float sinks to a predetermined lower level where the float cannot further sink;
the float retains the drain tube in an orientation so that water entering the opening is drained out of the chamber; and
the water level lowers until the float becomes buoyant.

17. A method for providing ebb and flow of water to a grow bed for plants, comprising:
positioning a chamber having a damper and a dosage float inside or adjacent to the grow bed;
receiving the water from a water source and providing the water to the grow bed;
utilizing the damper to restrict and channel a flow of the water in and out of the chamber; and
utilizing the dosage float to periodically release a measured volume of water back to the water source.

18. The method of claim 17, wherein the float enters a buoyant state, as water from the grow bed enter the chamber the float rises to a predetermined upper level where the float is prevented from further rising, the float receives the water into an opening in the float so that the float transitions to a non-buoyant state, the float sinks to a predetermined lower level, the float substantially releases the water back to the water source, and the float transitions back to the buoyant state to repeat the cycle.
